(19) United States
(12) Patent Application Publication
(10) Pub. No.: US 2026/0291036 A1
(43) Pub. Date: Sep. 24, 2026

(54) BATTERY PACK AND CIRCUIT BOARD ASSEMBLY

(71) Applicant: TECHTRONIC CORDLESS GP, Anderson, SC (US)

(72) Inventors: Hei Man LEE, Hong Kong (CN); Jin Hui ZHOU, Dongguan City (CN); Dian Wu XU, Dongguan City (CN); Kui ZENG, Dongguan City (CN); Pei LIAO, Dongguan City (CN)

(21) Appl. No.: 19/474,384

(22) PCT Filed: Apr. 13, 2023
(86) PCT No.: PCT/CN2023/088102

§ 371 Date: Oct. 10, 2025

(51) Int. Cl. H01M 50/583; H01M 10/42; H01M 50/247; H01M 50/284; H01M 50/519

(52) U.S. Cl. CPC H01M 50/583; H01M 10/4257; H01M 50/247; H01M 50/284; H01M 50/519; H01M 2200/103; H01M 2200/105

(57) ABSTRACT

Embodiments provide a battery pack including a housing with at least one terminal configured to electrically connect the battery pack to a power tool. The battery pack includes a battery cell support structure disposed within the housing. The battery cell support structure is configured to receive and support at least one battery cell. The battery pack includes a circuit board assembly for selectively providing power from the at least one battery cell to the at least one terminal. The circuit board assembly includes a first current-limiting device, and a second current-limiting device different from the first current-limiting device. The second current-limiting device is connected in series with the first current-limiting device.

### FIELD

Embodiments herein relate to battery packs.

### SUMMARY

Battery packs may include a current-limiting device, such as a fuse, to protect a battery pack controller from an overcurrent event. If the fuse is broken, it must be removed from the battery pack and replaced, or in some situations, the entire battery pack must be replaced.

Thus, one embodiment provides a battery pack including a housing with at least one terminal configured to electrically connect the battery pack to a power tool. The battery pack also includes a battery cell support structure disposed within the housing. The battery cell support structure is configured to receive and support at least one battery cell. The battery pack further includes a circuit board assembly for selectively providing power from the at least one battery cell to the at least one terminal. The circuit board assembly includes a first current-limiting device, and a second current-limiting device different from the first current-limiting device. The second current-limiting device is connected in series with the first current-limiting device.

In one aspect, the first current-limiting device is electrically connected between the at least one battery cell and the second current-limiting device, and the second current-limiting device is electrically connected between the first current-limiting device and the at least one terminal.

In one aspect, the first current-limiting device and the second current-limiting device are connected between the at least one battery cell and the at least one terminal.

In another aspect, the at least one terminal is a positive terminal or a negative terminal.

In another aspect, the second current-limiting device is configured to decrease its resistance as a temperature of the battery pack increases.

In another aspect, the second current-limiting device is in contact with a heat generating component of the circuit board assembly.

In another aspect, the heat generating component includes a MOSFET or the first current-limiting device.

In another aspect, the second current-limiting device is configured to reduce an inrush current received by the first current-limiting device in response to the battery pack being connected to the power tool via the at least one terminal.

In another aspect, the first current-limiting device is a fuse.

In another aspect, the second current limiting device is a negative temperature coefficient (NTC) resistor.

In another aspect, the second current limiting device includes a plurality of NTC resistors connected in parallel.

In another aspect, the second current limiting device is connected in parallel with a control element, such that the second current limiting device is bypassed after the startup of the battery pack.

In another aspect, the control element is controlled by an electronic processor included in the circuit board assembly, and the control element is a MOSFET.

In another aspect, the battery pack includes at least one semiconductor device electrically connected to the first current-limiting device.

Another embodiment provides a circuit board assembly for selectively providing power from at least one battery cell to at least one terminal of a battery pack. The circuit board assembly includes a first current-limiting device, and a second current-limiting device different from the first current-limiting device. The second current-limiting device is connected in series with the first current-limiting device.

In one aspect, the first current-limiting device is electrically connected between the at least one battery cell and the second current-limiting device, and the second current-limiting device is electrically connected between the first current-limiting device and the at least one terminal.

In another aspect, the first current-limiting device and the second current-limiting device are connected between the at least one battery cell and the at least one terminal.

In another aspect, the at least one terminal is a positive terminal or a negative terminal.

In another aspect, the second current-limiting device is configured to decrease its resistance as a temperature of the battery pack increases.

In another aspect, the second current-limiting device is in contact with a heat generating component of the circuit board assembly.

Other independent aspects of the invention may become apparent by consideration of the detailed description and accompanying drawings.

### BRIEF DESCRIPTION OF THE DRAWINGS

FIG. 1 illustrates a perspective view of a battery pack, according to some aspects.

FIG. 2 illustrates an exploded view of a battery pack, according to some aspects.

FIG. 3 illustrates a cross-sectional view of a battery pack, according to some aspects.

FIG. 4 illustrates a perspective view of a circuit board assembly, according to some aspects.

FIG. 5 schematically illustrates a circuit board assembly, according to some aspects.

FIG. 6 schematically illustrates a circuit board assembly, according to some aspects.

### DETAILED DESCRIPTION

Before any embodiments are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

Features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

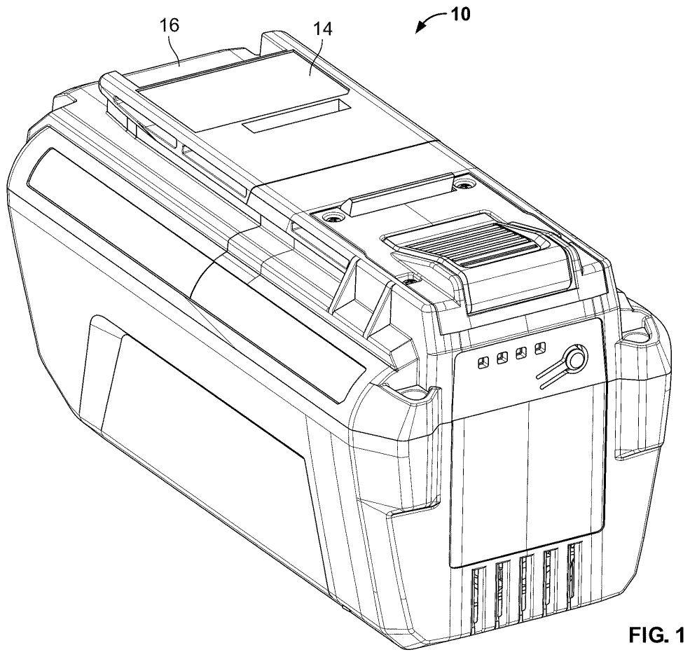

FIG. 1 illustrates a perspective view, in accordance with some embodiments, of a battery pack 10 including a battery pack housing 14 having at least one terminal 16 configured to electrically connect the battery pack 10 to an external device. In some embodiments, the battery pack 10 has a nominal voltage of 18 V and is connectable to and operable to power various hand-held power tools (e.g., drills, fasteners, saws, pipe cutters, sanders, nailers, staplers, vacuum cleaners, etc.), as well as other electrical devices. In some embodiments, the battery pack 10 has a nominal voltage of 40 V and is connectable to and operable to power various hand-held power tools (e.g., drills, fasteners, saws, pipe cutters, sanders, nailers, staplers, vacuum cleaners, etc.), as well as other electrical devices. In some embodiments, the battery pack 10 is configured to be a high power battery pack (e.g., having a nominal voltage of at least 80 volts (V)) connectable to and operable to power various motorized power tools (e.g., a cut-off saw, a miter saw, a table saw, a core drill, an auger, a breaker, a demolition hammer, a compactor, a vibrator, a compressor, a drain cleaner, a welder, a cable tugger, a pump, etc.), outdoor tools (e.g., a chain saw, a string trimmer, a hedge trimmer, a blower, a lawn mower, riding lawn mower etc.), other motorized devices (e.g., vehicles, utility carts, a material handling cart, etc.), and non-motorized electrical devices (e.g., a power source, a light, an AC/DC adapter, a generator, personal electronic device, etc.).

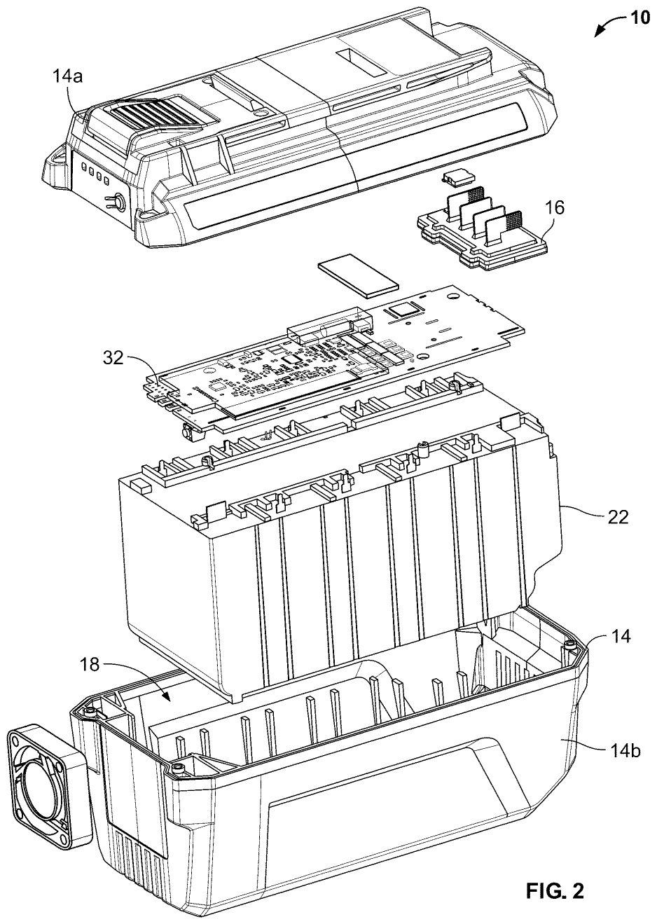

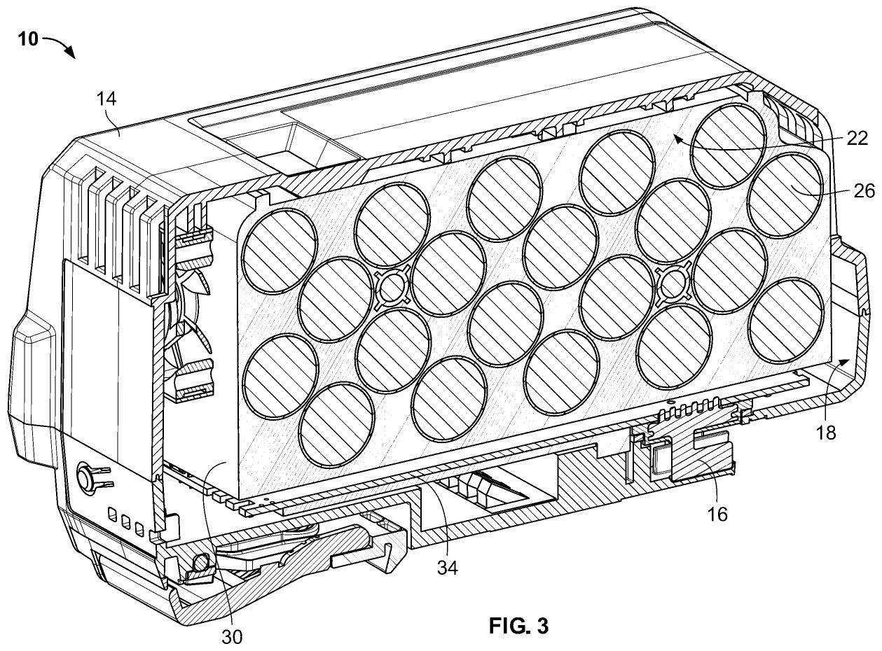

FIGS. 2 and 3 respectively illustrate an exploded view of the battery pack 10 and a cross-sectional view of the battery pack 10, in accordance with some embodiments. The battery pack housing 14 includes an upper housing portion 14a, a lower housing portion 14b, and an internal cavity 18 defined therewithin. A battery cell assembly 22 is positioned within the internal cavity 18. The battery cell assembly 22 may include a at least one battery cell 26 and a support structure 30 configured to receive and support the at least one battery cell 26 within the internal cavity 18. The battery pack housing 14 is shaped and sized to receive a predetermined number of battery cells 26 (e.g., one battery cell, two battery cells, ten battery cells, twenty battery cells, one-hundred battery cells, etc.). The at least one battery cell 26 may be connected in series, parallel, or combination series-parallel to provide the desired electrical characteristics (e.g., nominal voltage, current output, current capacity, power capacity, etc.) of the battery pack 10.

Each battery cell 26 may have a nominal voltage between about 3 V and about 5 V. For example, each battery cell 26 may have a nominal voltage of 3.6 V. Each battery cell 26 may have a nominal capacity between about 2 Ah and about 6 Ah (in some cases, between about 3 Ah and about 5 Ah). For example, in some embodiments each battery cell 26 has a nominal capacity of 3 Ah, or approximately 11 Watt-hours (Wh). In some embodiments, each battery cell 26 has a nominal capacity of 4 Ah, or approximately 14 Wh. The battery cells 26 may be any rechargeable battery cell chemistry type, such as, for example, lithium (Li), lithium-ion (Li-ion), and/or other lithium-based chemistry. Although illustrated as cylindrical battery cells, in other embodiments, the battery cell(s) 26 may be pouch cells, prismatic cells, or other suitable battery cells.

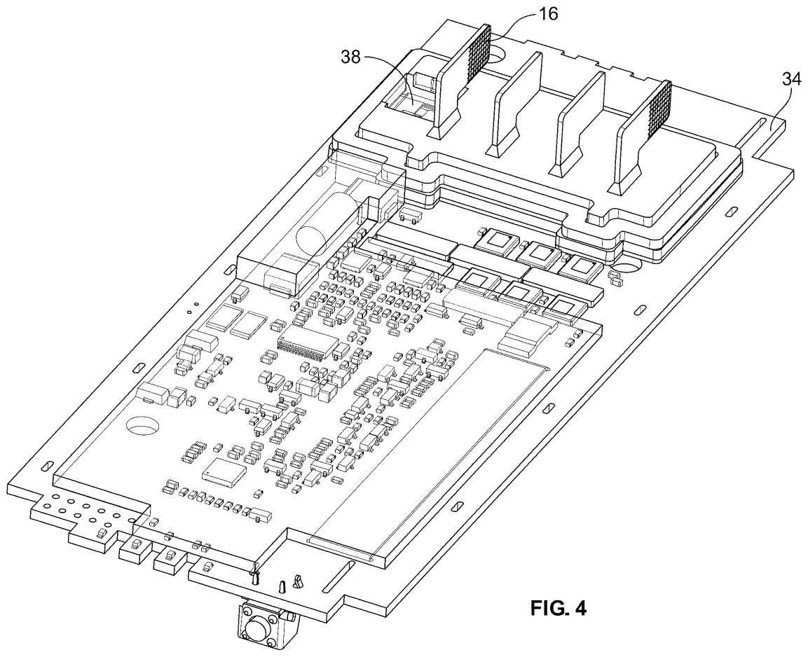

The battery pack housing 14 may also include a circuit board assembly 34 for providing operational control of the battery pack 10. FIG. 4 illustrates a perspective view of the circuit board assembly 34 according to some embodiments. The circuit board assembly 34 selectively provides power from the at least one battery cell 26 to the at least one terminal 16. The circuit board assembly 34 may include a controller (e.g., a microprocessor) configured to control one or more electrical components within the battery pack 10 in order to control charge/discharge of the at least one battery cell 26. The controller may further receive one or more signals from various sensors. Such signals may be indicative of one or more characteristics of the battery pack 10 and/or at least one battery cell 26 (for example, but not limited to, a voltage of the at least one battery cell 26, a current, and a temperature).

The circuit board assembly 34 may include a first current-limiting device 38, for example, a fuse, within a circuit of the circuit board assembly 34. The first current-limiting device 38 may be disposed between the at least one terminal 16 and one or more of the electrical components of the circuit board assembly 34 (e.g., one or more semiconductor devices, the controller, etc.) such that current will flow through the first current-limiting device 38 when the battery pack 10 is charging or discharging. In some instances, the first current-limiting device 38 is a fuse or fusible link configured to limit current (e.g., charging current or discharging current) flowing to the one or more electrical components of the circuit board assembly 34. The first current-limiting device 38 may be configured to break the circuit when the current in the battery pack 10 meets or exceeds a predetermined maximum amount. For example, the first current-limiting device 38 may be sized to limit current to approximately 100 Amps, 120 Amps, 150 Amps, or another suitable current limit value. When current flowing through the first current-limiting device 38 exceeds the current limit for a certain time, the first current-limiting device 38 may sever the current path between the at least one battery cell 26 and the at least one terminal 16.

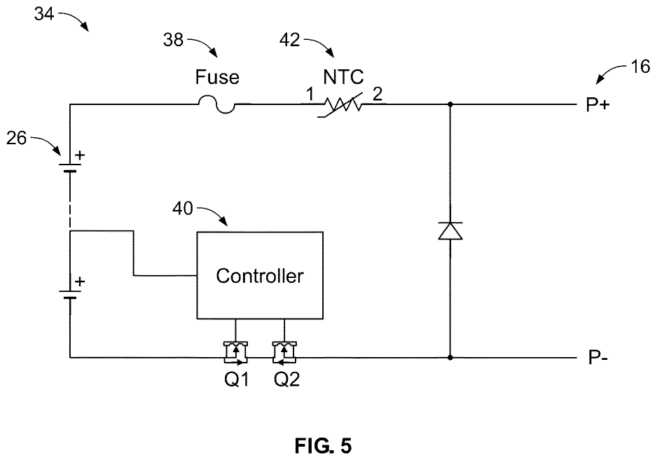

FIG. 5 schematically illustrates the circuit board assembly 34 according to some embodiments. The circuit board assembly 34 includes a controller 40 (e.g., an electronic processor), configured to control a first semiconductor switch Q1 (e.g., a MOSFET) and a second semiconductor switch Q2 for selectively providing power to a power tool via the at least one terminal 16. The circuit board assembly 34 further includes a second current-limiting device 42 electrically connected in series with the first current-limiting device 38. The second current-limiting device 42 may be different from the first current-limiting device 38. For example, the second current-limiting device 42 may be a current-limiting device other than a fuse. As illustrated in FIG. 5, the first current-limiting device 38 is electrically connected between the at least one battery cell 26 and the second current-limiting device 42. The second current-limiting device 42 is electrically connected between the first current-limiting device 38 and the at least one terminal 16.

The second current-limiting device 42 is configured to limit the amount of current received by the electrical components of the circuit board assembly 34 (e.g., the first current-limiting device 38, the first semiconductor switch Q1, the second semiconductor switch Q2, the controller 40, and/or other electrical components of the circuit board assembly 34). In some instances, the second current-limiting device 42 is a thermistor. For example, the second current-limiting device 42 may be a negative temperature coefficient (NTC) thermistor (or in some embodiments, two or more NTCs couped in an electrical parallel-configuration) configured to decrease a resistance in the current path between the at least one terminal 16 and the first current-limiting device 38 as a temperature of the battery pack 10 increases. For example, at startup (e.g., when the battery pack 10 is initially connected to a load), the temperature of the battery pack 10 may be at a first temperature which is lower than a normal operating temperature of the battery pack 10. The second current-limiting device 42 may therefore have a higher resistance, thus reducing an inrush current in the battery pack 10 during startup. Reducing inrush current in the battery pack 10 may reduce the risk that current in the battery pack 10 exceeds the current limit associated with the first current-limiting device 38. For example, reducing the inrush current may reduce the risk that the first current-limiting device 38 severs the electrical connection between at least one battery cell 26 and the at least one terminal 16 and, as a result, must be replaced. After startup, during operation of the battery pack 10 (e.g., as the battery pack 10 powers a power tool), the temperature of the battery pack 10 may increase to a normal operating temperature. As the temperature of the battery pack 10 increases, the resistance of the second current-limiting device 42 decreases, therefore allowing a greater amount of current to flow through the first current-limiting device 38, thus allowing the first current-limiting device 38 to operate normally and prevent over current due to an overload condition other than an inrush current at startup.

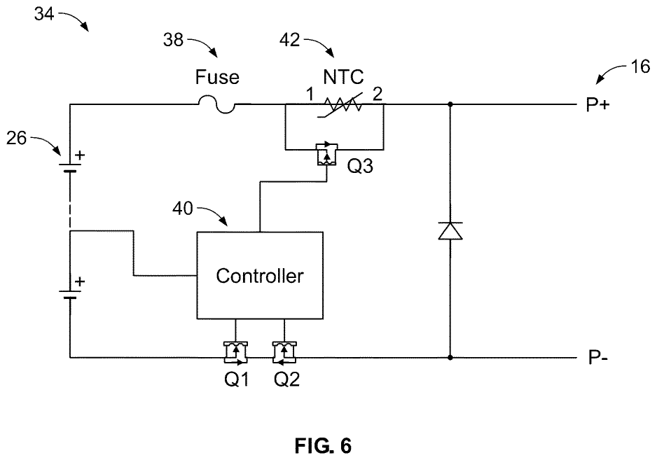

As illustrated in FIG. 6, in some instances, the circuit board assembly further includes a control element Q3 electrically connected in parallel with the second current-limiting device 42. The control element Q3 may be a semiconductor switch (e.g., a MOSFET) electrically connected to and controlled by the controller 40. The control element Q3 provides a current bypass for the second current-limiting device 42. For example, after a predetermined amount of time since startup of the battery pack 10, the controller 40 may output a control signal for controlling the control element Q3 to a closed state.

In some instances, the second current-limiting device 42 includes two or more current-limiting devices. For example, the second current-limiting device 42 may include two or more NTCs coupled in parallel in the circuit board assembly 34. The number of current-limiting devices included in the second current-limiting device 34 and configuration values associated with the second current-limiting device 34 may be selected based on one or more parameters associated with the battery pack 10 (e.g., a rated voltage or current output of the battery pack 10). Additionally, in some embodiments, the second current limiting device 42 may be in thermal contact with a heat generating element of the circuit board assembly 34 such that resistance of the second current-limiting device 34 may be reduced at a faster rate during startup of the battery pack 10. For example, the heat generating element may include the control element Q3, the first current-limiting device 38, a resistor, a capacitor, the first semiconductor switch Q1, and/or the second semiconductor switch Q2.

Although aspects of the present disclosure have been described in detail with reference to certain embodiments, variations and modifications exist within the scope and spirit of one or more independent aspects as described. Various features of the disclosure are set forth in the following claims.

What is claimed is:

1. A battery pack comprising:
a housing including at least one terminal configured to electrically connect the battery pack to a power tool;
a battery cell support structure disposed within the housing, the battery cell support structure configured to receive and support at least one battery cell; and
a circuit board assembly for selectively providing power from the at least one battery cell to the at least one terminal, the circuit board assembly including
a first current-limiting device, and
a second current-limiting device different from the first current-limiting device, the second current-limiting device connected in series with the first current-limiting device.

2. The battery pack of claim 1, wherein the first current-limiting device is electrically connected between the at least one battery cell and the second current-limiting device, and
wherein the second current-limiting device is electrically connected between the first current-limiting device and the at least one terminal.

3. The battery pack of claim 1, wherein the first current-limiting device and the second current-limiting device are connected between the at least one battery cell and the at least one terminal.

4. The battery pack of claim 3, wherein the at least one terminal is a positive terminal or a negative terminal.

5. The battery pack of claim 1, wherein
the second current-limiting device is configured to decrease its resistance as a temperature of the battery pack increases.

6. The battery pack of claim 1, wherein
the second current-limiting device is in contact with a heat generating component of the circuit board assembly.

7. The battery pack of claim 6, wherein the heat generating component includes a MOSFET or the first current-limiting device.

8. The battery pack of claim 1, wherein
the second current-limiting device is configured to reduce an inrush current received by the first current-limiting device in response to the battery pack being connected to the power tool via the at least one terminal.

9. The battery pack of claim 1, wherein
the first current-limiting device is a fuse.

10. The battery pack of claim 1, wherein
the second current limiting device is a negative temperature coefficient (NTC) resistor.

11. The battery pack of claim 8, wherein the second current limiting device includes a plurality of NTC resistors connected in parallel.

12. The battery pack of claim 1, wherein the second current limiting device is connected in parallel with a control element, such that the second current limiting device is bypassed after the startup of the battery pack.

13. The battery pack of claim 12, wherein the control element is controlled by an electronic processor included in the circuit board assembly, and the control element is a MOSFET.

14. The battery pack of claim 1, further comprising
at least one semiconductor device electrically connected to the first current-limiting device.

15. A circuit board assembly for selectively providing power from at least one battery cell to at least one terminal of a battery pack, the circuit board assembly comprising:
a first current-limiting device, and
a second current-limiting device different from the first current-limiting device, the second current-limiting device connected in series with the first current-limiting device.

16. The circuit board assembly of claim 15, wherein the first current-limiting device is electrically connected between the at least one battery cell and the second current-limiting device, and
wherein the second current-limiting device is electrically connected between the first current-limiting device and the at least one terminal.

17. The circuit board assembly of claim 15, wherein the first current-limiting device and the second current-limiting device are connected between the at least one battery cell and the at least one terminal.

18. The circuit board assembly of claim 17, wherein the at least one terminal is a positive terminal or a negative terminal.

19. The circuit board assembly of claim 15, wherein
the second current-limiting device is configured to decrease its resistance as a temperature of the battery pack increases.

20. The circuit board assembly of claim 15, wherein
the second current-limiting device is in contact with a heat generating component of the circuit board assembly.
